(19) United States
(12) Patent Application Publication
(10) Pub. No.: US 2016/0275767 A1
(43) Pub. Date: Sep. 22, 2016

(54) INTELLIGENT BEACON AND SYSTEM INCLUDING SAME

(71) Applicant: Menonthemoon Pty Ltd., Milton QLD (AU)

(72) Inventor: Simon Dell, Milton QLD (AU)

(21) Appl. No.: 14/739,480

(22) Filed: Jun. 15, 2015

(30) Foreign Application Priority Data
Mar. 16, 2015 (AU) 2015900926

(51) Int. Cl. G08B 13/24

(52) U.S. Cl. CPC G08B 13/2431

(57) ABSTRACT

A security tag to be attached to an article, each security tag including a housing with at least one releasable attachment mechanism to attach to the article; at least one resonator; at least one accelerometer; at least one wireless beacon for at least transmission of a signal to allow movement of the security tag to be tracked within an environment; and a power source to power components of the security tag.

### TECHNICAL FIELD

The present invention relates to security devices and systems and to the use of improved security devices and systems for enhancing consumer interactivity with goods during the purchasing process.

### BACKGROUND ART

Electronic article surveillance (EAS) is a technological method for preventing shoplifting from retail stores, pilferage of books from libraries or removal of properties from office buildings. Special tags are fixed to merchandise or books. These tags are removed or deactivated by the clerks when the item is properly bought or checked out. At the exits of the store, a detection system sounds an alarm or otherwise alerts the staff when it senses active tags. Some stores also have detection systems at the entrance to the bathrooms that sound an alarm if someone tries to take unpaid merchandise with them into the bathroom. For high-value goods that are to be manipulated by the patrons, wired alarm clips may be used instead of tags.

There are a number of different types of systems including magnetic, also known as magneto-harmonic, acousto-magnetic, also known as magnetostrictive, radio frequency and microwave.

A single EAS detector, suitable for a small shop, usually costs several thousand dollars or euros. Disposable tags cost a matter of cents and may have been embedded during manufacture. More sophisticated systems are available, which are more difficult to circumvent. These systems and tags are much more expensive, due to the use of more complex electronics and components.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an intelligent security tag and system including same, which may at least partially overcome at least one of the abovementioned disadvantages or provide the consumer with a useful or commercial choice.

With the foregoing in view, the present invention in one form, resides broadly in an intelligent security tag system including
a) at least one security tag to be attached to an article, each security tag including:
   i) a housing with at least one releasable attachment mechanism to attach to the article;
   ii) at least one resonator;
   iii) at least one accelerometer;
   iv) at least one wireless beacon for at least transmission of a signal; and
   v) a power source to power components of the security tag; and
b) at least one software application to collect data from the security tag as to movement of the security tag within an environment.

In another form, the present invention resides in an intelligent security tag system including
b) at least one security tag to be attached to an article, each security tag including:
   i) a housing with at least one releasable attachment mechanism to attach to the article;
   ii) at least one resonator;
   iii) at least one accelerometer;
   iv) at least one wireless beacon for at least transmission of a signal; and
   v) a power source to power components of the security tag; and
b) at least one first software application operating on an electronic device to generate and display at least one interface on the electronic device when triggered by the signal from the security tag; and
c) at least one second software application to collect data from the security tag as to movement of the security tag within an environment.

In yet another form the present invention resides in at least one security tag to be attached to an article, each security tag including a housing with at least one releasable attachment mechanism to attach to the article; at least one resonator; at least one accelerometer; at least one wireless beacon for at least transmission of a signal to allow movement of the security tag to be tracked within an environment; and a power source to power components of the security tag.

The intelligent security tag system of the present invention preferably incorporates both security tag functionality as well as beacon and accelerometer technology. Preferably, the security tag of the present invention secures the item within the environment by providing an alarm if the tag passes security gates and also provides an enhanced customer experience. The security tag also allows data collection about the shopping habits and movement about the environment using the security tag.

Typically, the security tag system will be shop or business based. The security tags will normally be linked to a store network. There may be external data reporting and/or data collection and/or data analysis. Preferably, the security tag will be used to establish a geo-fence in relation to the store environment to prevent products with tags attached thereto, leaving the store environment without recognition. As mentioned, the security tags can also be used to track the movement of the products with the tag attached within the geo-fenced environment.

The system of the present invention includes at least one security tag to be attached to an article. Preferably, a plurality of security tags are provided as a part of a system for each store or environment. The security tag may be attached to all items in store or to selected pieces only. The security tag can be attached directly or indirectly to the product or item. For example, the security tag can be attached to a swing tag, or coathanger but directly to the label or the item is preferred. Any attachment mechanism can be used.

The article to which is security tag is attached may be any type of article. Preferably, a security tag is attached to items which are available for sale. Security tags can be attached to a surface, but this will typically not utilise the security functionality of the tag. A security tag may be mounted on one or more surfaces within the environment in order to provide location information of other tags within the system.

Each security tag will typically be relatively small and light weight and in some instances, the aesthetics of the security tag will be important.

Each security tag typically includes a housing with at least one releasable attachment mechanism to attached to the article. Preferably, the housing would generally contain all of the components of the security tag except a portion of the attachment mechanism. A portion of the attachment mechanism will typically be mounted to or extend from the outside of the housing. In some embodiments, a portion of the security tag will be removable and attachable to the housing in order to attach the security tag to an item or product.

The housing will preferably be a multipart housing. Preferably, at least two parts are provided which are attachable together in order to close the housing to contain the components of the housing within. The housing may be fluid tight. One or more seals can be provided to seal the housing.

The housing can be shaped in a particular way. In a particularly preferred embodiment, the housing will have a top cover and a bottom case. Preferably, components will be mounted relative to a printed circuit board and placed within the bottom case with the top cover attached thereto to close the housing.

A retention portion or lock mechanism is typically provided inside for retaining a portion of the attachment mechanism. Depending upon the attachment mechanism used, an opening may be provided in the housing in communication with the retention portion or lock mechanism within the housing.

The housing can be made from any material but a plastic material is particularly preferred. It is also preferred that the housing components clip or snap together. The housing may require a tool to open the housing. Preferably however the only reason for opening the housing will be to access the battery or other internal components and therefore, the housing will typically remain closed to prevent tampering in an effort to defeat the security.

The at least one releasable attachment mechanism preferably includes a locking mechanism which usually consists of a clutch that will accept and lock a metal pin that can be inserted through a product at the retail store. There are numerous designs of clutches, but one example is a metal plate with a small hole in the middle. The hole is preferably too small for the pin's shaft to pass through unless the metal plate is flexed to enlarge the hole. Once the pin is inserted, the plate flattens, and the minimized hole fits around a grooved section in the shaft of the pin. To release this grip, the sales clerk inserts the tag into a magnetic device that flexes the clutch plate, allowing the pin to slide free. Another example of a clutch type is a ring of small balls or spheres that encircle the pin, with a spring mechanism pressing the balls into a groove in the pin's shaft; a magnetic deactivator retracts the balls from the groove, releasing the pin. Still other tag designs use a mechanical deactivator that inserts a probe into the tag to physically disengage a locking device.

Typically, the metal pin has a sharpened end and an enlarged head portion. The metal pin is typically received through an article or other item such as a label or a swing tag attached to the article to be secured and engages with the locking mechanism within the housing.

Further, there may be a metal or similar cable which is passed through or around a portion of an object or item and then secured to or in the locking mechanism of the housing.

The housing may have other components provided such as an ink release mechanism.

Inside each housing is a resonator, a device that picks up a transmitted signal and repeats it. The resonator is typically a part of the security portion of the tag. A set of gates provided at the entry and/or exit of the environment also contains a receiver that is programmed to recognize whether it is detecting the target signal during the time gaps between the pulses being broadcast by the gates. Sensing a signal during these intervals indicates the presence of a signal being resonated (rebroadcast) by a security tag in the detection zone. When this occurs, the gates sound an alarm; in some systems, the alarm sound is accompanied by a flashing light.

There are several ways a resonator can be made. One technique involves laminating copper or aluminium coils onto a web of nonconductive material. This is done by passing the adhesive-coated base web between rollers that apply a spiral-shaped mask of non-sticky material, after which the web passes through a dryer to set the mask. A thin, flat strip of metal is then laminated to the uncoated (sticky) portion of the base web. The laminated strip subsequently passes between a backup roller and a cutting roller, which cuts through the metal but not the base web, disconnecting the individual metal coils from one another. This masking and laminating process is repeated, adding a layer of web with metal spirals atop the first layer so that the two layers of spirals are face to face, separated by a layer of dielectric (nonconductive) material. Finally, the laminated strip is cut into individual resonators that can be inserted into security tags.

Another type of resonator is made by winding insulated (encased in plastic) copper wire into a flat spiral of about a dozen loops, with the ends of the wire connected through a diode. One company makes a button-shaped tag that can operate with a very small-diameter coil because the wire is spiralled into a cone shape.

The security tag of the present invention also preferably includes an accelerometer which is preferably provided to detect movement of the security tag. The accelerometer can be used to count the number of movements or may be used in combination with the location functionality to work out where an item is picked up and wherein item is put down for example as well as how long the item is carried and where the item is taken within the store environment. The accelerometer can be used to interact or prompt the beacon to transmit for example, while the accelerometer is moving.

The security tag of the present invention also includes a wireless beacon for at least transmission of a signal. The beacon typically includes a transmitter. The wireless beacon will preferably transmit upon the occurrence of an event or may alternatively transmit a signal periodically or constantly.

The emitted signal is normally a radiofrequency but any appropriate frequency can be used. A particularly preferred signal will be a Bluetooth signal as Bluetooth signal can be detected by devices such as smart phones or tablets without requiring pairing with the beacon issuing a signal. The signal can be simple or complex. In a particularly preferred form, the signal will be a simple identification code which is unique to the particular beacon and therefore, to the particular product to which the security tag is attached.

If the signal contains instructions and/or data, then the signal is preferably transmitted to a device for interpretation and/or implementation by a software application operating on the device.

The signal can be a multicomponent signal with portions provided for different purposes. The signal can be a multiuse signal. Further, the signal can be a directed signal or a broadcast signal. The signal may be directed to a number of locations. As mentioned above, each beacon will typically have a unique signal or a signal containing unique information to identify the particular tag so that data from that security tag can be identified and preferably logged. Normally, the security tag is associated with a particular article in a database. The security tag is capable of being disassociated from that article and being associated with the different article. Management software is normally provided for that purpose. The management software may be provided as a part of or related to the second software application.

Typically, the signal issued by a wireless beacon triggers action on the part of either or both of the first and/or second software applications. This will be explained further in the context of the particular software applications.

Normally, the signal will be a broadcast signal to any device operating a provided software application within a particular range. The broadcast signal may also be detected for the purposes of the second software application.

One wireless beacon may transmit different signals based on the proximity of a particular device. Further, one wireless beacon may transmit different signals based on the type of device or the type of event which triggers the transmission of signal. Normally, the beacon is associated with the accelerometer in order to trigger a transmission if the accelerometer detects movement of the product.

The signal of the beacon of a security tag can also be used to establish the position or location of the beacon of a security tag within the environment. Any method can be used. Typically, smart phones or other devices are configured to detect a Bluetooth signal without pairing and also to calculate the distance of the smart phone or device from the beacon based on signal strength. If the initial position of the beacon of a security tag is known, then this can give the location of the electronic device within the environment.

Alternatively, if a system including security tags attached to products and fixed location beacons is used, then the location of the security tag can be identified over time. One or more fixed beacons may be used in association with the security tags of the present invention in order to calculate the location of the security tags within the system. The fixed beacons are preferably fixed so that their locations are fixed in order to use the fixed locations as the basis for the location calculation. This is a variation of radio direction finding based on triangulation.

Alternatively, many smart phones or other devices have location functionality as a part of their design. The signal of the beacon can be used to query the location receiver of the nearest smart phone or other device and use that information to locate the electronic device and/or security tag. This method is less preferred.

Preferably, the location of the security tag is identifiable on second by second basis as this will allow more precise location information to be gathered. If an array of fixed beacons is provided within the environment, the location and movement of security tag is attached to products can be tracked with some precision, even within a relatively small store.

The security tag of the present invention includes at least one power source. The power source can have any form but clearly a wireless power source or self contained power source is preferred. The most preferred power source is one or more on board batteries. The one or more batteries can be rechargeable. The one or more batteries can be replaceable. The batteries will preferably hold charge for extended periods, even up to years of time. A port communicable with the on board batteries may be provided to allow the batteries to be recharged without removal from the housing. Removeable batteries are preferred.

The system of the present invention may include at least one first software application operating on an electronic device to generate and display at least one interface when triggered by the signal from at least one security tag. Typically, the electronic device is one which is carried by or viewable by a customer at a store or shop or display of goods bearing a security tag.

Any type of electronic device may be used to carry the software application. Typically, the electronic device is a personal computing device for example a smartphone, or tablet or similar computing device with a processor, display screen, memory for storing instructions in the form of one or more software applications and capable of receiving a signal from the beacon of one or more tags. The personal computing device will also preferably have at least one, multidirectional communications pathway to obtain data from a remote source.

The first software application will normally be obtained via download from a supplier of applications such as for example, Google Play or iTunes or similar. The software application will typically be downloaded from the supplier to the electronic device and stored thereon for use as required by the customer. Depending upon the mode of operation, the software application can be quite small in size. For example, if all the software application is required to do is receive and transmit the ID code present in a signal from one or more security tag, then the software application may be as simple as a recognition algorithm coupled with a set of transmission instructions to send the ID code to a specific remote location in order to receive instructions and/or data in return which is then used to generate and display the interface on the display of the electronic device.

Once installed, the software application receives the signal from one or more security tags, each of which preferably includes or triggers the production and display of an interface on the electronic device to a potential customer in relation to the product to which the security tag is attached.

The software application may include a media or content player or similar. The signal may contain the data relating to the production and display of the interface and the information thereon, but preferably the software application will enable the electronic device to identify the product through a unique ID code to a remote server and receive data in return relating to the production and display of the interface and the information in relation to the product.

The signal from the security tag may be triggered by movement of the product to which the security tag is attached detected via the accelerometer or may be a periodically issued signal which is received by electronic devices based on proximity of the device to the tag. Due to the ability to use a Bluetooth signal to establish the distance between the electronic device and the product, the signal may be received without triggering production and display of an interface bearing information relating to the product until the electronic device moves into a particular range of the product with the security tag. This trigger distance may be adjustable by the customer or management.

As mentioned above, the signal may contain sufficient information to cause production and display of an interface or alternatively and more preferred is that the signal contains a unique ID code to identify the product and once received by the software application, the software application will access or request information, data, and/or instructions stored remotely to allow the electronic device to produce and display an interface containing information relating to the particular product. Normally, this information, data, and/or instructions are stored on a remote database, accessible through one or more wireless communications pathways.

The database may be a local database, that is, particular to a store, chain or location or the database may be located on a computer network accessible from any location, by any number of stores, owned by any number of owners. So a local store can operate their own database or store information relating to their products on a larger, shared database.

The interface displayed may take any form to showcase information relating to the product in order to inform the customer or to enhance the shopping experience. Any type or combination of content can be used. Typically the instructions relating to the interface and the information thereon are stored in one or more files which once the electronic device receives the signal from a security tag identifying the particular security tag and thereby, the product to which the security tag is attached, the corresponding file is typically provided to the electronic device for production and display of an interface thereon.

The system of the present invention may include at least one second software application to collect data rom the security tag as to movement of the security tag within an environment. Preferably, the data collected will inform as to the habits of shoppers, potential shoppers, and traffic areas within a store and/or products that are more popular for example, as well as to track the location of items within the store for security purposes.

The data collected will normally be used to optimise store management in relation to product placement as well as to inform the store management as to product popularity and customer preferences.

Any type of information can be collected and the information may be analysed and/or displayed in any useable manner. Typically the information collected will be analysed for patterns which can inform store management as to optimisation of the store or product positioning. Normally, graphical representations of the store with one or more overlays are provided showing different information sets or summaries. Heat maps are particularly useful to show movement patterns as they are normally more descriptive or understandable than the raw data itself.

In some cases, graphs and/or tables can be used. The representation used will normally be dependent upon the information which has been collected and/or the parameter being examined.

Stock management can be integrated into the second software application in order to associate a security tag with a product for tracking purposes. Individual products may be tracked or general movement of products within the store.

Normally the second software application will be accessed or maintained by the store management. The software application may be sold to a store for their use or a licence to access the software application may be provided.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a plan view of a security tag according to a particularly preferred embodiment of the present invention.

FIG. 2 is a side elevation view of a security tag according to a particularly preferred embodiment of the present invention.

FIG. 3 is an end elevation view of a security tag according to a particularly preferred embodiment of the present invention.

FIG. 4 is a view from below of the security tag illustrated in FIG. 2.

FIG. 5 is an exploded isometric view of the security tag illustrated in FIGS. 1 to 4.

FIG. 6 is an isometric view of the security tag illustrated in FIGS. 1 to 4.

FIG. 7 is an isometric view from above of the security tag illustrated in FIG. 6 with the fixing pin released from the attachment mechanism.

FIG. 8 is an isometric view from below of the security tag illustrated in FIG. 6 with the fixing pin released from the attachment mechanism.

FIG. 9 is an isometric view of a shirt with a security tag according to a preferred embodiment of the present invention attached to.

FIG. 10 is a schematic illustration of a particularly preferred embodiment of the system of the present invention in operation showing information flow.

FIG. 11 is a schematic plan view of a shop layout with fixed beacons and security tags associated with products according to a preferred embodiment of the present invention.

FIG. 12 is one form of heat map generated using information collected from a system of a particularly preferred embodiment of the present invention.

FIG. 13 is an alternative form of heat map generated using information from the system of a particularly preferred embodiment of the present invention.

### DESCRIPTION OF EMBODIMENTS

According to a particularly preferred embodiment of the present invention, an intelligent security tag system is provided.

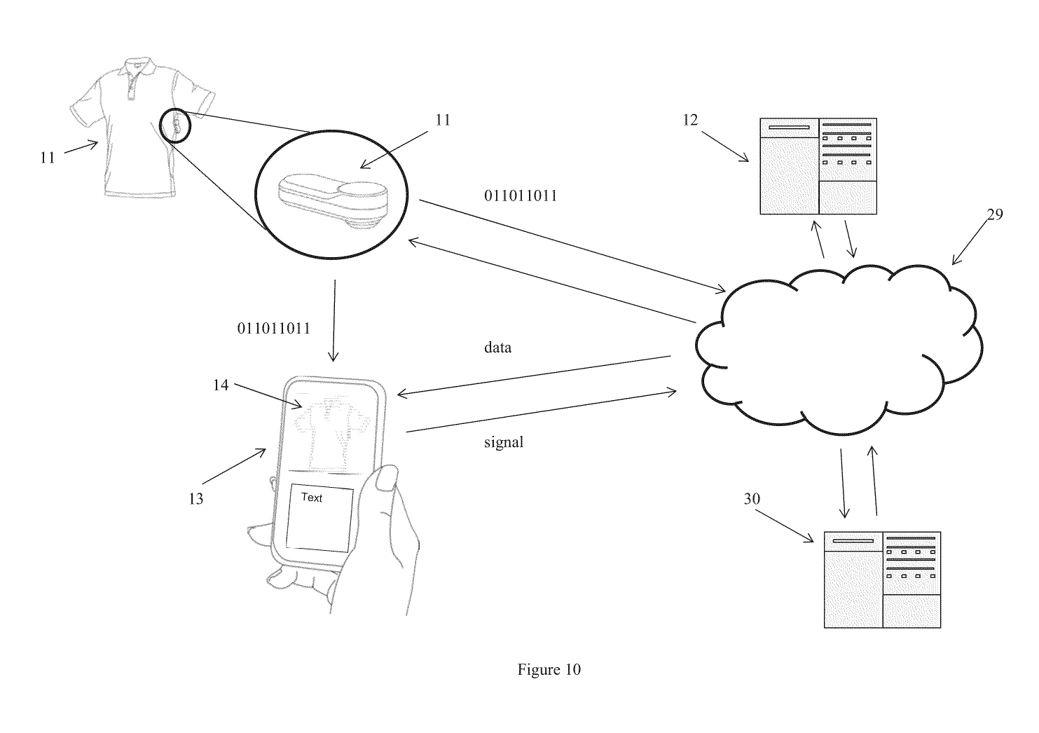

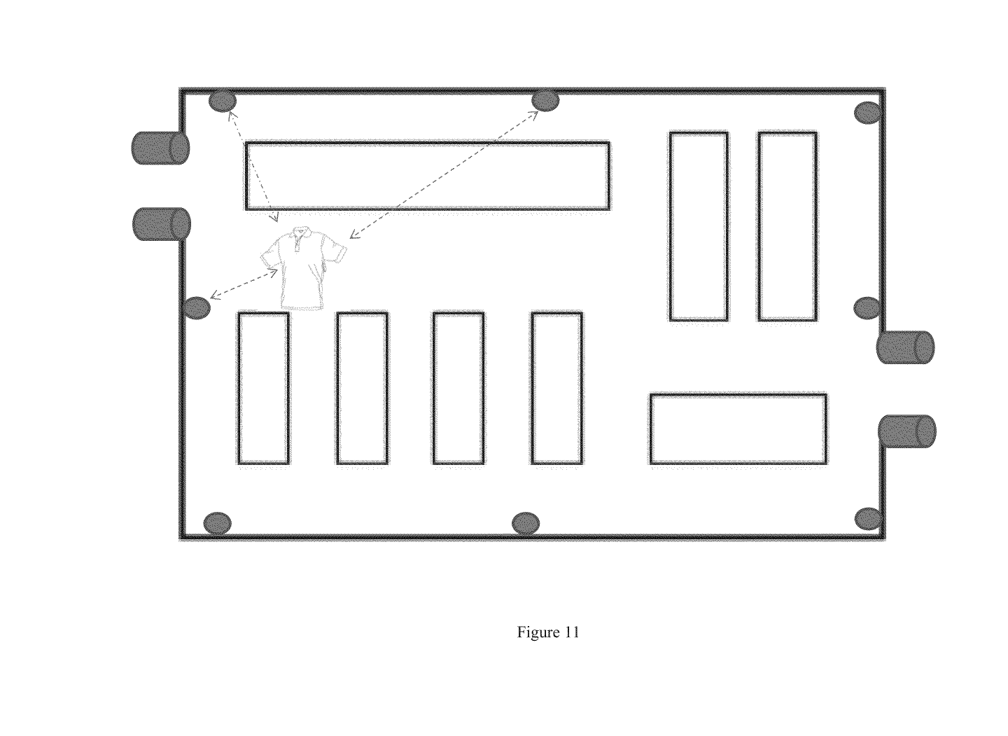

The intelligent security tag system of the preferred embodiment illustrated in FIG. 10 includes a number of security tags 10, each to be attached to an article 11, a software application operating on a server 12 to collect data from the security tag 10 as to movement of the security tag 10 within the store environment and a software application operating on an smartphone 13 to generate and display an interface 14 on the smartphone 13 when triggered by a signal from the security tag 10.

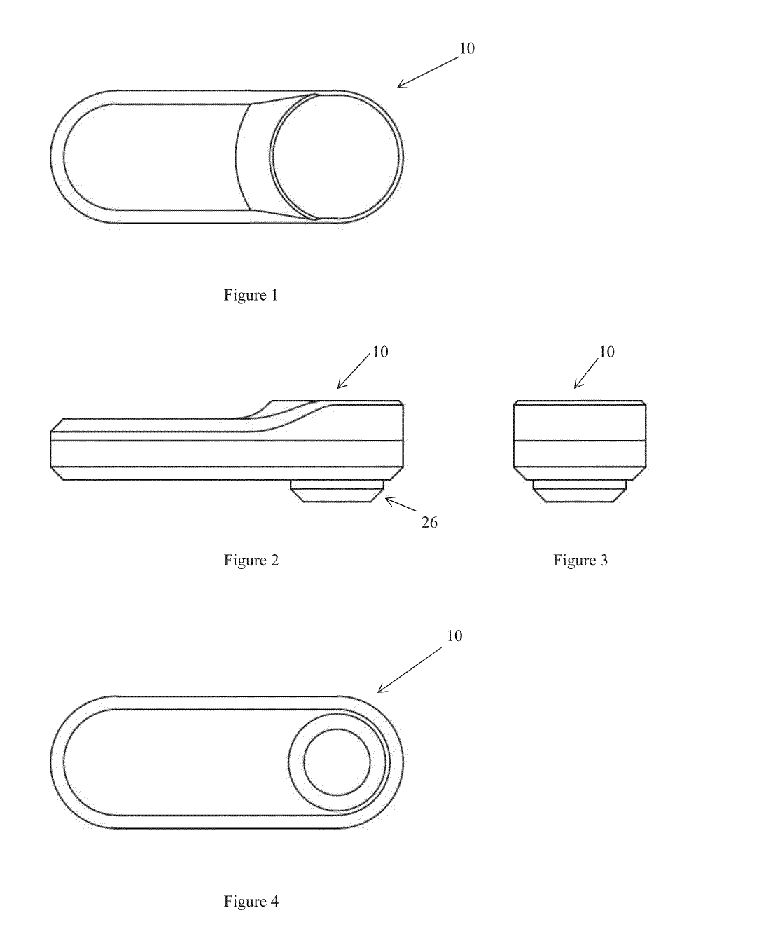

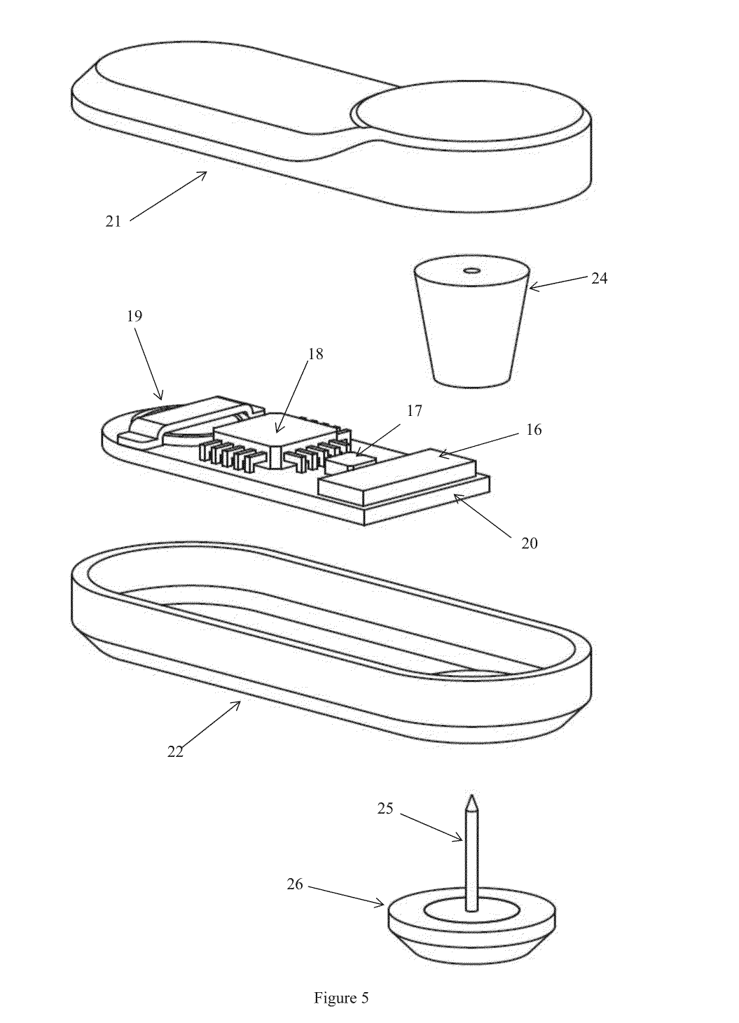

As illustrated in FIGS. 1 to 6, each security tag 10 includes a housing 15 with a releasable attachment mechanism to attach to the article 11. A resonator 16, an accelerometer 17, a wireless beacon 18 for at least transmission of a signal, and a battery 19 to power components of the security tag 10 are illustrated in FIG. 5 mounted to a printed circuit board 20.

Each security tag will typically be relatively small and light weight.

Each security tag 10 typically includes a housing 15 with a releasable attachment mechanism to attach to the article. According to the embodiment illustrated in FIG. 5, the housing contains all of the components of the security tag 10 except a portion of the attachment mechanism. In the illustrated embodiment, a portion of the security tag is removable and attachable to the housing.

The housing has a top cover 21 and a bottom case 22. The internal components are mounted relative to the printed circuit board 20 and placed within the bottom case 22 with the top cover 21 attached thereto to close the housing.

The attachment mechanism used in the illustrated embodiment includes an opening 23 in the housing in communication with the retention portion in the form of a magnetic lock 34 within the housing.

The housing can be made from any material but a plastic material is particularly preferred. It is also preferred that the housing components clip or snap together.

The illustrated releasable attachment mechanism includes a locking mechanism 34 which usually consists of a clutch that will accept and lock a metal pin 25 that can be inserted through a product at the retail store. There are numerous designs of clutches, but one example is a metal plate with a small hole in the middle. The hole is too small for the metal pin shaft to pass through unless the metal plate is flexed to enlarge the hole. Once the pin is inserted, the plate flattens, and the minimized hole fits around a grooved section in the shaft of the pin. To release this grip, the sales clerk inserts the tag into a magnetic device that flexes the clutch plate, allowing the pin to slide free.

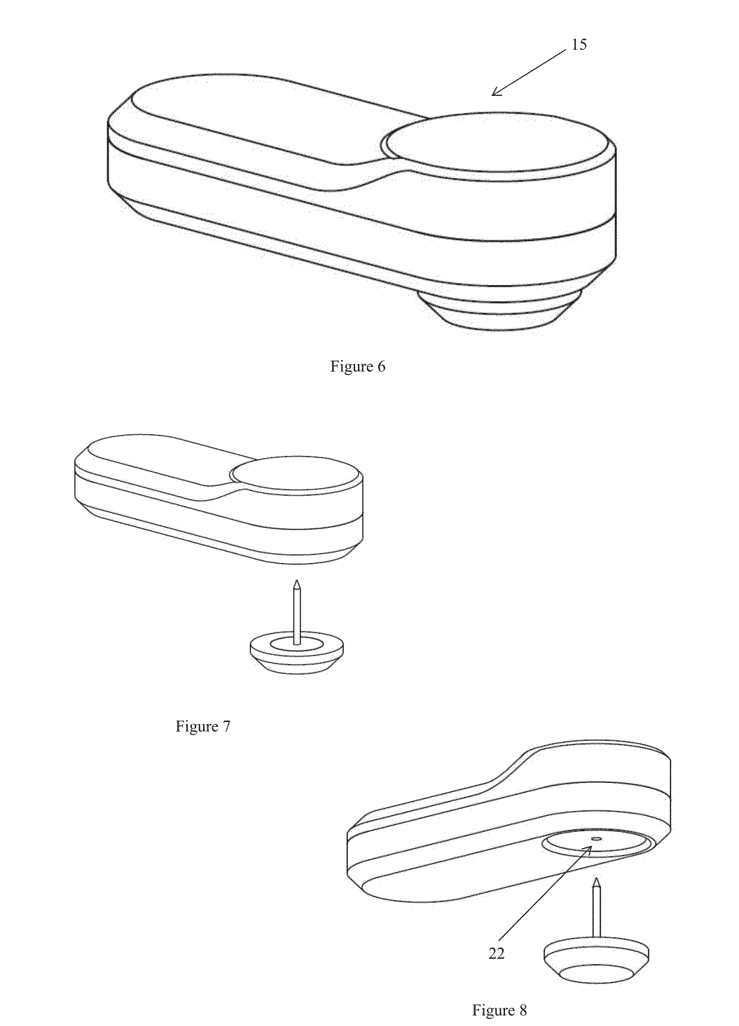

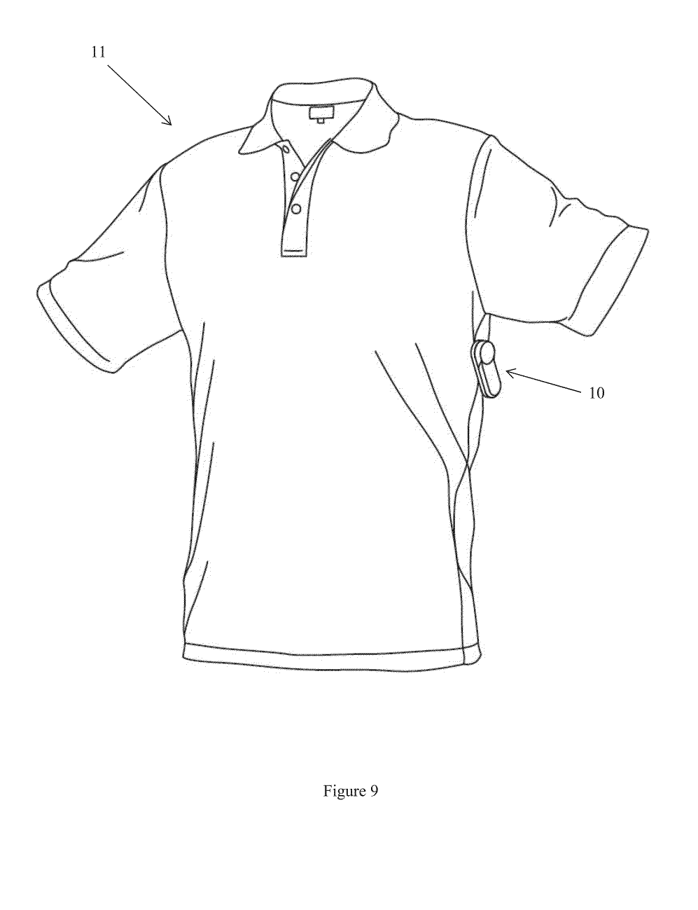

As illustrated in FIGS. 5 to 8, the metal pin 25 has a sharpened end and an enlarged head portion 26. The metal pin 25 is typically received through an article or other item such as a label or a swing tag attached to the article to be secured and engages with the locking mechanism 24 within the housing.

Inside each housing is a resonator, a device that picks up the transmitted signal and repeats it. The resonator is typically a part of the security portion of the tag. A set of security gates 27 provided at the entry and/or exit of the environment, one example of which is illustrated in FIG. 11, also contains a receiver that is programmed to recognize whether it is detecting the target signal during the time gaps between the pulses being broadcast by the gates. Sensing a signal during these intervals indicates the presence of a signal being resonated (rebroadcast) by a security tag in the detection zone. When this occurs, the gates sound an alarm; in some systems, the alarm sound is accompanied by a flashing light.

There are several ways a resonator can be made. One technique involves laminating copper or aluminium coils onto a web of nonconductive material. This is done by passing the adhesive-coated base web between rollers that apply a spiral-shaped mask of non-sticky material, after which the web passes through a dryer to set the mask. A thin, flat strip of metal is then laminated to the uncoated (sticky) portion of the base web. The laminated strip subsequently passes between a backup roller and a cutting roller, which cuts through the metal but not the base web, disconnecting the individual metal coils from one another. This masking and laminating process is repeated, adding a layer of web with metal spirals atop the first layer so that the two layers of spirals are face to face, separated by a layer of dielectric (nonconductive) material. Finally, the laminated strip is cut into individual resonators that can be inserted into security tags.

Another type of resonator is made by winding insulated (encased in plastic) copper wire into a flat spiral of about a dozen loops, with the ends of the wire connected through a diode. One company makes a button-shaped tag that can operate with a very small-diameter coil because the wire is spiralled into a cone shape.

The security tag of the present invention also preferably includes an accelerometer which is preferably provided to detect movement of the security tag. The accelerometer can be used to count the number of movements or may be used in combination with the location functionality to work out where an item is picked up and wherein item is put down for example as well is how long the item is carried. The accelerometer can be used to interact or prompt the beacon to transmit for example, while the accelerometer is moving.

The security tag of the present invention also includes a wireless beacon for at least transmission of a signal. The beacon typically includes a transmitter. The wireless beacon will preferably transmit upon the occurrence of an event or may alternatively transmit a signal periodically or constantly.

The emitted signal is normally a radio frequency but any appropriate frequency can be used. A particularly preferred signal will be a Bluetooth signal as Bluetooth signal can be detected by devices such as smart phones or tablets without requiring pairing with the beacon issuing a signal. The signal can be simple or complex. In a particularly preferred form, the signal will be a simple identification code which is unique to the particular beacon. If the signal contains instructions, then the signal is preferably transmitted to a device for interpretation and/or implementation by a software application operating on the device.

The signal can be a multicomponent signal with portions provided for different purposes. The signal can be a multiuse signal. Further, the signal can be a directed signal or a broadcast signal. The signal may be directed to a number of locations. As mentioned above, each beacon will typically have a unique signal or a signal containing unique information to identify the particular tag so that data from that security tag can be identified and logged. Normally, the security tag is associated with a particular article. The security tag is capable of being disassociated from that article and being associated with the different article. Management software is normally provided for that purpose usually related to the tracking software. The management software may be provided as a part of or related to the second software application.

Typically, the signal issued by a wireless beacon triggers action on the part of either or both of the first and/or second software applications. This will be explained further in the context of the particular software applications.

Normally, the signal will be a broadcast signal to any device operating a provided software application within a particular range. The broadcast signal may also be detected for the purposes of the second software application.

One wireless beacon may transmit different signals based on the proximity of a particular device. Further, one wireless beacon may transmit different signals based on the type of device or the type of event which triggers the transmission of signal. Normally, the beacon is associated with the accelerometer in order to trigger a transmission if the accelerometer detects movement of the device.

The signal of the beacon can also be used to establish the position or location of the beacon of a security tag within the environment. Any method can be used. Typically, smart phones or other devices are configured to detect a Bluetooth signal without pairing and also to calculate the distance of the smart phone or device from the beacon based on signal strength. If the initial position of the beacon of a security tag is known, then this can give the location of the electronic device within the environment. Alternatively, if a system including security tags 10 attached to products and an array of fixed location beacons 28 is used, then the location of the security tag can be identified over time. This configuration is illustrated in FIG. 11.

As mentioned above, a number of fixed beacons 28 may be used in association with the security tags 10 of the present invention in order to calculate the location of the security tags 10 within the system. The fixed beacons 28 are preferably fixed so that their locations are fixed in order to use the fixed locations as the basis for the location calculation.

If necessary, the smartphone 13 can further probe a signal provided by a beacon for increased stability. This is a variation of radio direction finding based on triangulation.

Preferably, the location of the security tag is identifiable on second by second basis as this will allow more precise location information to be gathered. If an array of fixed beacons 28 is provided within the store, the location and movement of security tag 10 which is attached to products can be tracked with some precision.

The power source can have any form but clearly a wireless power source or self contained power source such as a one or more on board batteries 19 is preferred.

The preferred embodiment includes a first software application operating on a smartphone 13 to generate and display interface 14 when triggered by the signal from the security tag 10 as illustrated in FIG. 10.

The smartphone also has a multidirectional communications pathway to obtain data from a remote source as illustrated in FIG. 10.

The software application will normally be obtained via download from a supplier of applications such as for example, Google Play or iTunes or similar and is downloaded from the supplier to the smartphone and stored thereon for use as required by the customer. Depending upon the mode of operation, the software application can be quite small in size. For example, if all the software application is required to do is receive and transmit the ID code present in a signal from one or more security tag as is required in the preferred configuration illustrated in FIG. 10, then the software application may be as simple as a recognition algorithm coupled with a set of transmission instructions to send the ID code to a specific remote location in order to receive data in return.

Once installed, the software application receives the signal from one or more security tags to trigger the production and display of an interface on the electronic device to a potential customer in relation to the product to which the security tag is attached. Preferably the software application enables the smartphone 13 to identify the product through a unique ID code to a remote server and receive data in return relating to the production and display of the interface 14 and the information in relation to the product.

The signal from the security tag may be triggered by movement of the product to which the security tag is attached or may be a periodically issued signal which is received by electronic devices based on proximity of the device to the tag. Due to the ability to use a Bluetooth signal to establish the distance between the electronic device and the product, the signal may be received without triggering production and display of an interface bearing information relating to the product until the electronic device moves into a particular range of the product.

As mentioned above, the signal contains a unique ID code to identify the product and once received by the software application, the software application will access or request information, data, and/or instructions stored remotely to allow the electronic device to produce and display an interface containing information relating to the particular product. Normally, this information, data, and/or instructions are stored on a remote database, accessible through one or more wireless communications pathways 29 and server 30.

The database may be a local database, that is, particular to a store, chain or location or the database may be located on a computer network accessible from any location. So a local store can operate their own database or store information relating to their products on a larger, shared database.

The interface displayed may take any form to showcase information relating to the product. Any type or combination of content can be used. Typically the instructions relating to the interface and the information thereon are store in one or more files which once the electronic device receives the signal from s security tag, are provided to the electronic device for production and display of an interface.

The system of the present invention may include a second software application to collect data from the security tag as to movement of the security tag within an environment. Preferably, the data collected will inform as to the habits of shoppers, potential shoppers, traffic areas within a store and/or products that are more popular as well as to track the location of items within the store for security purposes. This software application normally resides on a server 12 (which may be the same server 30 or different thereto).

The data collected will normally be used to optimise store management in relation to product placement as well as to inform the store management as to product popularity and customer preferences.

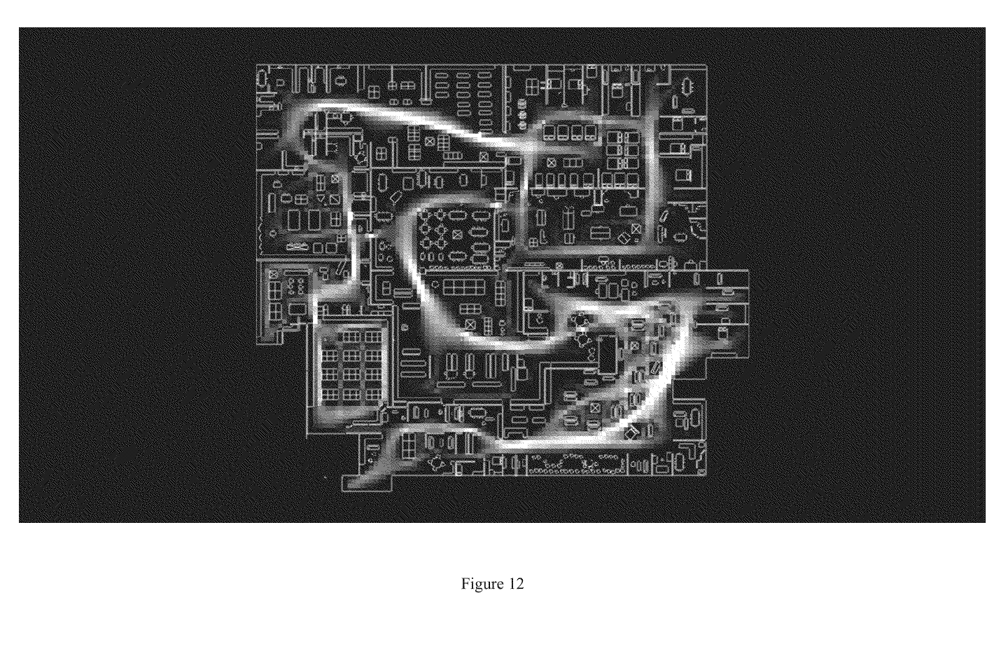

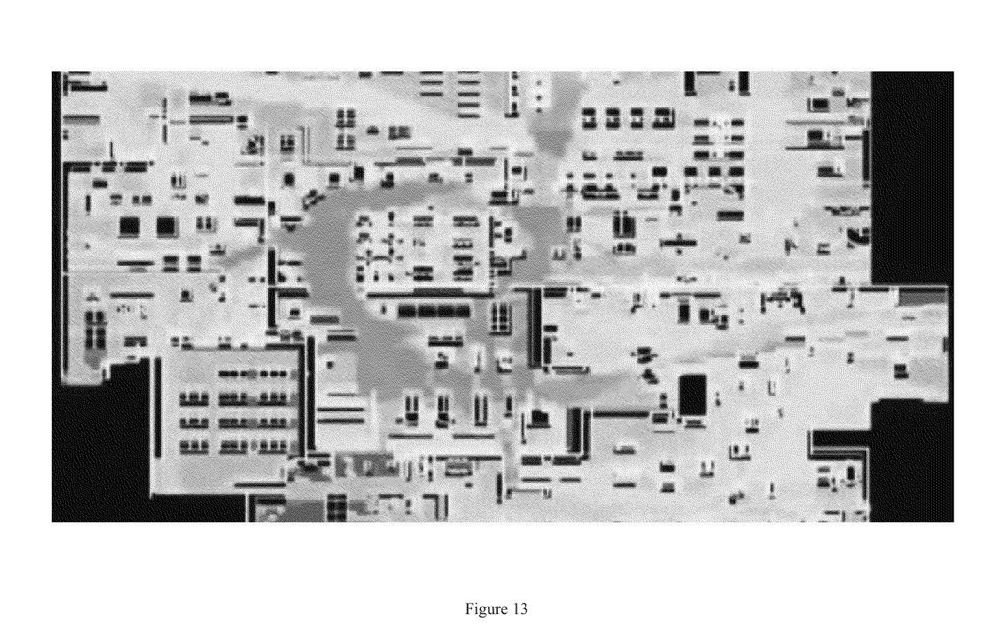

Any type of information can be collected and the information may be analysed and/or displayed in any useable manner. Typically the information collected will be analysed for patterns which can inform store management as to optimisation of the store or product positioning. Normally, graphical representations of the store with one or more overlays provided showing different information sets or summaries. Heat maps such as those illustrated in FIGS. 12 and 13 are particularly useful to show movement patterns as they are normally more descriptive or understandable than the data itself.

Stock management can be integrated into the second software application in order to associate a security tag with a product for tracking purposes. Individual products may be tracked or general movement of products within the store.

Normally the second software application will be accessed or maintained by the store management. The software application may be sold to a store for their use or a licence to access the software application may be provided.

The intelligent security tag system of the present invention preferably incorporates both security tag functionality as well as beacon and accelerometer technology. Preferably, the security tag secures the item within the environment and also provides an enhanced customer experience. The security tag also allows data collection about the shopping habits and movement about the environment using the security tag.

Typically, the security tag system will be shop or business based. The security tags will normally be linked to a store network. There may be external data reporting and/or data collection and/or data analysis. Preferably, the security tag will be used to establish a geo-fence in relation to the store environment to prevent products with tags attached thereto, leaving store environment without recognition. As mentioned, the security tags can also be used to track the movement of the products with the tag attached within the geo-fenced environment.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An intelligent security tag system including
1. at least one security tag to be attached to an article, each security tag including:
i) a housing with at least one releasable attachment mechanism to attach to the article;
ii) at least one resonator;
iii) at least one accelerometer;
iv) at least one wireless beacon for at least transmission of a signal; and
v) a power source to power components of the security tag; and
b) at least one software application to collect data from the security tag as to movement of the security tag within an environment.

2. An intelligent security tag system as claimed in claim 1 wherein the signal of the at least one wireless beacon is used to establish the position or location of the beacon of a security tag within the environment.

3. An intelligent security tag system as claimed in claim 1 wherein the system includes mobile security tags attached to products and fixed location beacons in in order to calculate the location of the mobile security tags within the system.

4. An intelligent security tag system including
a) at least one security tag to be attached to an article, each security tag including:
i) a housing with at least one releasable attachment mechanism to attach to the article;
ii) at least one resonator;
iii) at least one accelerometer;
iv) at least one wireless beacon for at least transmission of a signal; and
v) a power source to power components of the security tag; and
b) at least one first software application operating on an electronic device to generate and display at least one interface on the electronic device when triggered by the signal from the security tag; and
c) at least one second software application to collect data from the security tag as to movement of the security tag within an environment.

5. An intelligent security tag system as claimed in claim 4 wherein the signal issued by at least one wireless beacon triggers action on the part of either or both of the first and/or second software applications.

6. An intelligent security tag system as claimed in claim 4 wherein the signal issued by at least one wireless beacon is a broadcast signal to any device operating the at least one first software application within a particular range.

7. An intelligent security tag system as claimed in claim 4 wherein the electronic device is a personal computing device chosen from the group including a smartphone, tablet or similar computing device with a processor, display screen, memory for storing instructions in the form of one or more software applications and capable of receiving a signal from the at least on wireless beacon of one or more security tags.

8. An intelligent security tag system as claimed in claim 4 wherein the signal of the at least one wireless beacon is used to establish the position or location of the beacon of a security tag within the environment.

9. An intelligent security tag system as claimed in claim 4 wherein the system includes mobile security tags attached to products and fixed location beacons in in order to calculate the location of the mobile security tags within the system.

10. An intelligent security tag system as claimed in claim 4 wherein the location of the security tag is identifiable on second by second basis to allow more precise location information to be gathered

11. An intelligent security tag system as claimed in claim 4 wherein the data collected is analysed for patterns to inform store management as to optimisation of store layout or product positioning.

12. A security tag to be attached to an article, each security tag including a housing with at least one releasable attachment mechanism to attach to the article; at least one resonator; at least one accelerometer; at least one wireless beacon for at least transmission of a signal to allow movement of the security tag to be tracked within an environment; and a power source to power components of the security tag.

13. A security tag as claimed in claim 12 wherein the housing is a multipart housing having at least two parts are provided attachable together in order to close the housing to contain components within.

14. A security tag as claimed in claim 12 wherein the at least one accelerometer prompts the beacon to transmit a signal.

15. A security tag as claimed in claim 12 wherein the signal is a simple identification code which is unique to a particular beacon and therefore, to a particular product to which the security tag is attached.

16. A security tag as claimed in claim 12 wherein the signal contains instructions and data for transmission to an electronic device for implementation by a software application operating on the electronic device.

17. A security tag as claimed in claim 12 wherein the signal is a multicomponent signal with portions provided for different purposes.

18. A security tag as claimed in claim 12 wherein each beacon transmits a signal containing unique information to identify the particular security tag so that data from that security tag can be identified and logged.

19. A security tag as claimed in claim 12 wherein the at least one wireless beacon transmits different signals based on proximity of a particular electronic device.

20. A security tag as claimed in claim 12 wherein the at least one wireless beacon transmits a different signal based on an event type which triggers transmission of the signal.
